(19) United States
(12) Patent Application Publication
(10) Pub. No.: US 2010/0235560 A1
(43) Pub. Date: Sep. 16, 2010

(54) INPUT/OUTPUT EXPANSION DEVICE FOR PORTABLE ELECTRONIC APPARATUS

(75) Inventors: Soo Young Oh, Daejeon (KR); Hye Yong Chu, Daejeon (KR); Kyoung Ik Cho, Daejeon (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/299,135

(22) PCT Filed: May 9, 2007
(86) PCT No.: PCT/KR07/02266

§ 371 Date: Oct. 31, 2008

(30) Foreign Application Priority Data
May 9, 2006 (KR) 10-2006-0041333
Sep. 7, 2006 (KR) 10-2006-0086033

(51) Int. Cl. G06F 13/10

(52) U.S. Cl. 710/301

(57) ABSTRACT

Provided is an input/output (I/O) expansion device for a portable electronic apparatus having a port to which an external expansion device can be connected. The I/O expansion device includes: a display body having at least one display portion; and at least one I/O connector formed at a portion of the display body to be electrically and physically attached to and separated from the port of the portable electronic apparatus. Therefore, it is possible to provide a multi-function I/O expansion device that can be electrically and physically attached and separated.

### TECHNICAL FIELD

The present invention relates to an input/output (I/O) expansion device for a portable electronic apparatus, and more particularly, to an I/O expansion device for a portable electronic apparatus capable of enlarging a display unit of the conventional portable electronic apparatus and also increasing functions by attaching a short-range information recognition and transfer apparatus, a biosensor, etc.

### BACKGROUND ART

With the development of the information and communication industry, the initial cellular phone for only voice communication is being developed into a convergence device having the functions of a digital camera, a Moving Picture Experts Group (MPEG) layer 3 (MP3) player, etc. Lately, various optional electronic devices, such as a sensor having various functions, an information storage apparatus, etc., are integrated in such a mobile device, and thus functions of the mobile device are diversified. However, an appropriate power supply is needed to operate such integrated electronic devices, and also the size and weight of the power supply must be appropriate for the mobile device.

Until now, cellular phones have been used in a mode for data communication, such as voice communication, games, and MP3, other modes using a storage medium, or other modes. However, when various functions are integrated in a cellular phone as mentioned above, the weight and size of the cellular phone increase, and thus it becomes difficult to carry the cellular phone. In addition, since the basic power source of the cellular phone is not sufficient for all the functions, the cellular phone is used for a shorter period of time.

### DISCLOSURE OF INVENTION

### Technical Problem

The present invention is directed to an input/output (I/O) expansion device for a portable electronic apparatus that can be physically and electrically connected with the portable electronic apparatus according to a user s demand and expand functions of the electronic apparatus.

The present invention is also directed to an I/O expansion device for a portable electronic apparatus that can be carried separately from an electronic apparatus and also improve its portability using an ultra-thin and lightweight plastic substrate, a metal foil substrate, a specially processed thin film glass substrate, etc.

The present invention is also directed to an I/O expansion device having an additional power supply and thus can be used for a longer period of time.

### Technical Solution

One aspect of the present invention provides an input/output (I/O) expansion device for a portable electronic apparatus having a port to which an external expansion device can be connected, the I/O expansion device comprising: a display body having at least one display portion; and at least one I/O connector formed at a portion of the display body to be electrically and physically attached to and separated from the port of the portable electronic apparatus.

Another aspect of the present invention provides an I/O expansion device for a portable electronic apparatus having a port to which an external expansion device can be connected, the I/O expansion device comprising: a display body having at least one display portion; at least one I/O connector formed at a portion of the display body; and an interface cable connected to the I/O connector and the port to electrically and physically connect the display body with the portable electronic apparatus.

The display body may further comprise at least one functional electronic device connection port for connection with a functional electronic device to be electrically and physically attached to and separated from the I/O expansion device, and may display information received from the functional electronic device connected with the connection port on the display portion or transfer it to the portable electronic apparatus. The functional electronic device may comprise at least one of a blood-sugar sensor, a blood-pressure sensor, a heartbeat sensor, a radio frequency (RF) sensor, an optical sensor, a temperature sensor, a humidity sensor, and an information processor.

The I/O expansion device may further comprise a power supply formed in the display body to supply power to the display body. The power supply may comprise at least one of a polymer battery, a solar cell, and a fuel-cell battery.

The display body may use one of a plastic substrate, an ultra-thin glass substrate in which at least one of an upper surface and a lower surface is coated with a polymer layer, and a metal foil substrate. On the substrate used in the display body, a printed circuit board (PCB) for facilitating electrical and physical attachment and separation of the functional electronic device may be formed. The plastic substrate may be formed of one of polyethylene terephthalate (PET), polycarbonate (PC), polyethersulfone (PES), and polyimide (PI). The metal foil substrate may be formed of one of stainless steel and aluminum The display portion may be integrated using at least one of a liquid crystal display (LCD), an organic light emitting diode (OLED), and e-paper.

### Advantageous Effects

According to the present invention, it is possible to expand functions of a portable electronic apparatus using an input/output (I/O) expansion device that can be electrically and physically attached to and separated from the portable electronic apparatus. In addition, the portability of the I/O expansion device can be improved by fabricating the I/O expansion device using an ultra-thin and lightweight plastic substrate, a metal foil substrate, a specially processed thin film glass substrate, etc. to be carried separately from an electronic apparatus.

In addition, by a rechargeable power supply provided for the I/O expansion device, it is possible to easily supply power additionally required for enlargement of a display unit. In particular, when a solar cell, etc. is attached, the power supplied to the expansion device is generated from the expansion device itself, and thus power can be supplied without limitation.

Furthermore, by connecting various functional electronic devices, e.g., a blood-sugar sensor, a blood-pressure sensor, a heartbeat sensor, an optical sensor, a temperature sensor, a humidity sensor, etc., to a functional electronic device connection port formed in the expansion device, it is possible to provide a multi-function I/O expansion device suited to the ubiquitous era.

### BRIEF DESCRIPTION OF THE DRAWINGS

FIG. 1A is an exploded perspective view of a portable electronic apparatus and an input/output (I/O) expansion device that is connected with the portable electronic apparatus according to an exemplary embodiment of the present invention;

FIG. 1B is a perspective view of the portable electronic apparatus equipped with the I/O expansion device shown in FIG. 1A;

FIG. 2 is a cross-sectional view taken along line II-II of FIG. 1B;

FIG. 3 is an exploded perspective view of a portable electronic apparatus and an I/O expansion device that is connected with the portable electronic apparatus according to another exemplary embodiment of the present invention; and

FIGS. 4A and 4B illustrate the front side and a schematic block diagram of the back side of an I/O expansion device for a portable electronic apparatus according to still another exemplary embodiment of the present invention.

### DESCRIPTION OF MAJOR SYMBOLS IN THE ABOVE FIGURES

100: Portable electronic apparatus

101, 102: Body

103: Hinge

104: Input unit

105: Display unit

110: Port

150: I/O expansion device

151: Display body

152: Display portion

153: I/O connector

154: Power supply

155: Connection port

156: Power switch

160: Interface cable

160a and 160b: Cable connectors

### MODE FOR THE INVENTION

Hereinafter, exemplary embodiments of the present invention will be described in detail. However, the present invention is not limited to the exemplary embodiments disclosed below, but can be implemented in various types. Therefore, the present exemplary embodiments are provided for complete disclosure of the present invention and to fully inform the scope of the present invention to those ordinarily skilled in the art.

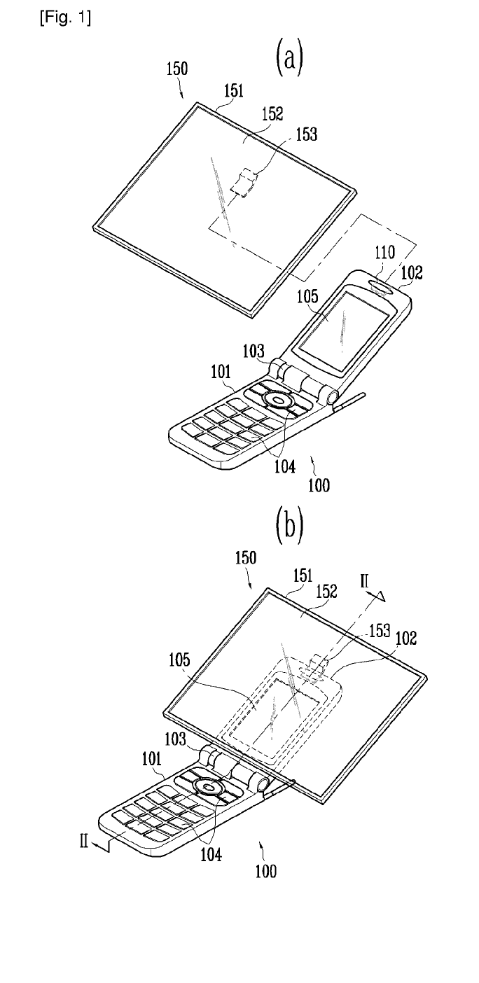

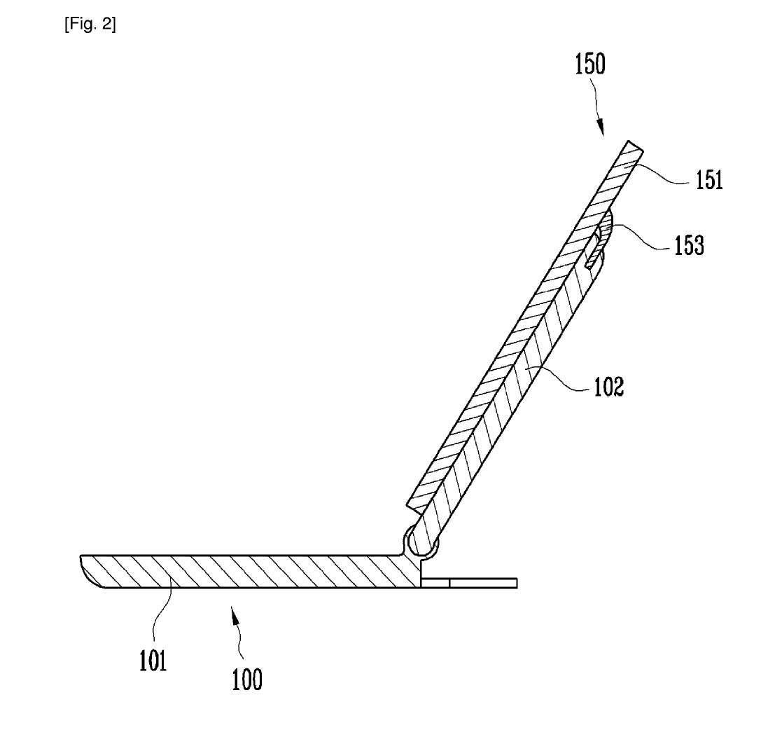

FIG. 1A is an exploded perspective view of a portable electronic apparatus and an input/output (I/O) expansion device that is connected with the portable electronic apparatus according to an exemplary embodiment of the present invention. FIG. 1B is a perspective view of the portable electronic apparatus equipped with the I/O expansion device shown in FIG. 1A. FIG. 2 is a cross-sectional view taken along line II-II of FIG. 1B.

As illustrated in the drawings, a cellular phone is given as an example of the portable electronic apparatus. However, the present invention is not limited to a cellular phone but may be used for various portable electronic apparatuses, such as a Digital Multimedia Broadcasting (DMB) phone, a Moving Picture Experts Group (MPEG) layer 3 (MP3) player, a Personal Digital Assistant (PDA), etc.

Referring to FIGS. 1A and 1B, the portable electronic apparatus used in this exemplary embodiment is a cellular phone 100. The cellular phone is a dual-folder type phone whose two bodies 101 and 102 are connected by a hinge 103. An input unit 104, e.g., buttons, a touch panel, etc., through which a user inputs desired information is disposed in one body 101, and a display unit 105 displaying information according to an electrical signal applied via the input unit 104 is disposed in the other body 102. In the body 102 of the cellular phone 100, at least one port 110 to which various external expansion devices, etc. can be connected is formed. In this exemplary embodiment, the port 110 is formed in the upper part of the body 102, but the position of the port 110 is not limited thereto.

An I/O expansion device 150 connected to the port 110 is connected with the cellular phone 100 via the port 110. The I/O expansion device 150 includes a display body 151 having at least one display portion 152, and at least one I/O connector 153 that can be connected to the port 110 of the cellular phone 100 to be attached to and separated from the port 110.

According to the above described constitution, the I/O expansion device 150 connected with the cellular phone 100 may be supplied with power from the cellular phone 100. Although not shown in the drawings of this exemplary embodiment, an additional power supply for supplying power to the I/O expansion device 150 may be formed. In addition, the I/O expansion device 150 is electrically connected with the input unit 104 of the cellular phone 100, receives information input from outside through the input unit 104, and displays the input information on the display portion 152. Needless to say, it is preferable that a circuit required for displaying the information is formed in the bodies 101 and 102 of the cellular phone 100. Since the basic constitution and the connection of the input unit 104 and the display portion 152 are the same as those of a common cellular phone, descriptions thereof will be omitted in this exemplary embodiment. In addition, power is supplied from the cellular phone in this exemplary embodiment, but the additional power supply may be formed in the I/O expansion device 150.

More specifically, the I/O expansion device 150 according to the present invention uses one of a plastic substrate, a metal foil substrate, and an ultra-thin glass substrate. The plastic substrate may use polyethylene terephthalate (PET), polycarbonate (PC), polyethersulfone (PES), polyimide (PI), and so on. The metal foil substrate may use stainless steel, aluminum, and so on. A polymer layer is deposited on or attached to at least one of the upper surface and the lower surface of the ultra-thin glass substrate, thereby preventing breakage of the glass substrate.

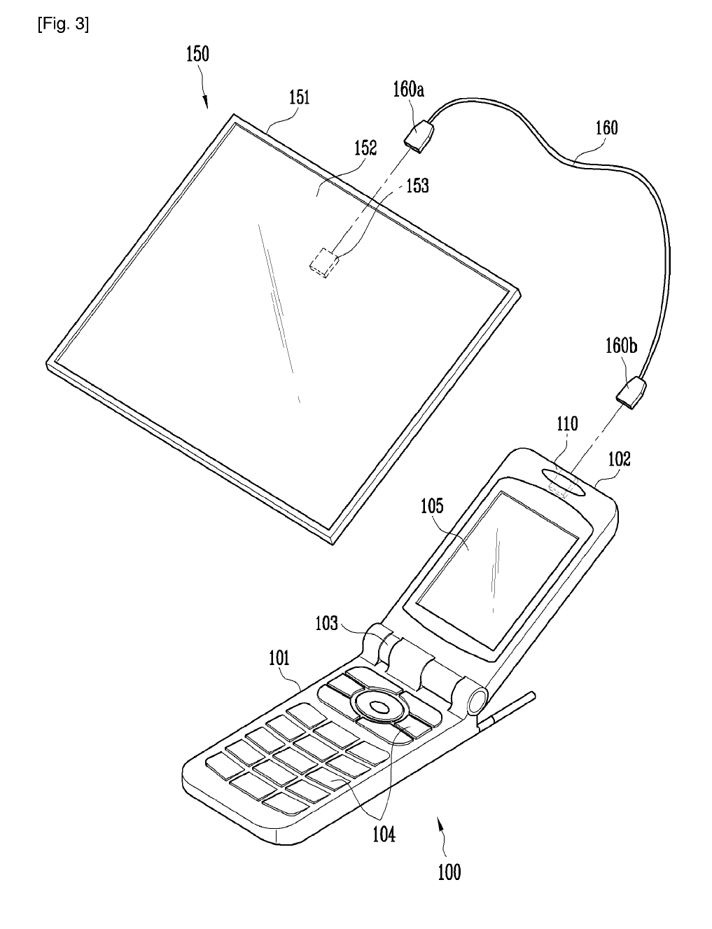

FIG. 3 is an exploded perspective view of a portable electronic apparatus and an I/O expansion device that is connected with the portable electronic apparatus according to another exemplary embodiment of the present invention.

Referring to FIG. 3, the portable electronic apparatus used in this exemplary embodiment is a cellular phone 100. The cellular phone is a dual-folder type phone whose two bodies 101 and 102 are connected by a hinge 103. The structure of the portable electronic apparatus is the same as that shown in FIGS. 1A and 1B, and thus it is recommended to refer to the previous descriptions of FIGS. 1A and 1B.

An I/O expansion device 150 is connected with the cellular phone 100 via a port 110 disposed in the cellular phone 100. The I/O expansion device 150 includes a display body 151 having at least one display portion 152, an I/O connector 153 disposed in the display body 151, and an interface cable 160 electrically and physically connecting the cellular phone 100 with the I/O expansion device 150. At both ends of the interface cable 160, a pair of cable connectors 160a and 160b connected to the port 110 of the cellular phone 100 and the I/O connector 153 of the I/O expansion device 150 are disposed.

According to the above described constitution, the I/O expansion device 150 connected with the cellular phone 100 via the interface cable 160 may be supplied with power from the cellular phone 100. Although not shown in the drawings of this exemplary embodiment, an additional power supply for supplying power to the I/O expansion device 150 may be formed. In addition, the I/O expansion device 150 is electrically connected with the input unit 104 of the cellular phone 100, receives information input from outside through the input unit 104, and displays the input information on the display portion 152. Needless to say, it is preferable that a circuit required for displaying the information is formed in the bodies 101 and 102 of the cellular phone 100. Since the basic constitution and the connection of the input unit 104 and the display portion 152 are the same as those of a common cellular phone, descriptions thereof will be omitted in this exemplary embodiment.

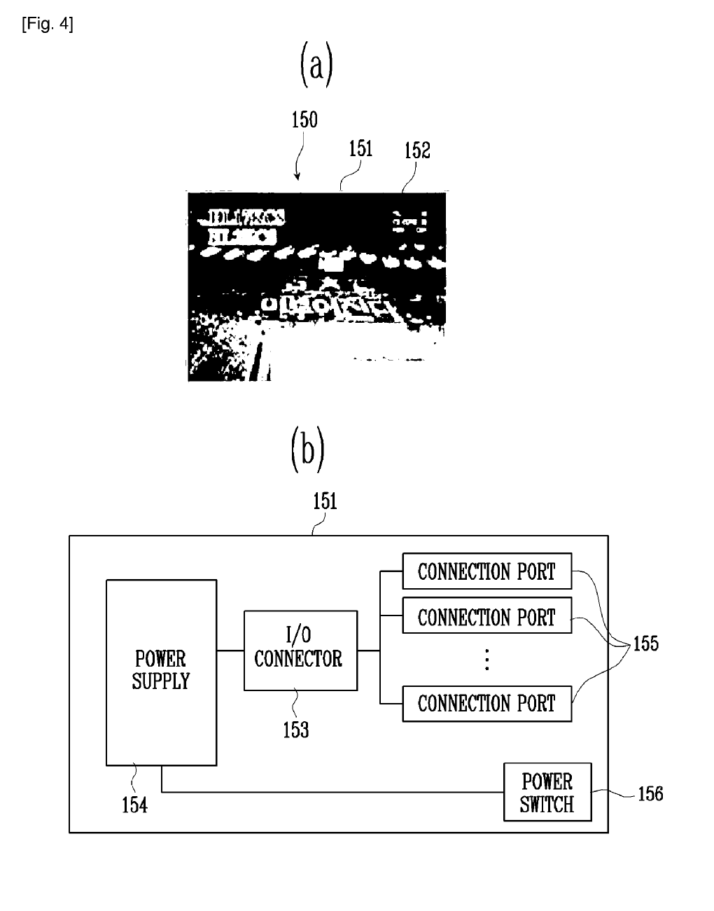

FIGS. 4A and 4B illustrate the front side and a block diagram of the back side of an

I/O expansion device for a portable electronic apparatus according to still another exemplary embodiment of the present invention. Referring to FIGS. 4A and 4B, an I/O expansion device 150 according to this exemplary embodiment comprises: a display body 151 having a display portion 152; an I/O connector 153 for connection with a portable electronic apparatus; a power supply 154 for supplying power to the display body 151; and at least one functional electronic device connection port 155 for connection with various external functional electronic devices (not shown in the drawings). In this exemplary embodiment, the connector 153, the power supply 154, and the connection ports 155 are formed in the back side of the expansion device 150. In addition, a power switch 156 for supplying and interrupting power is further formed in the back side.

The display body 151 may use a lightweight, thin, and unbreakable substrate, i.e., one of a plastic substrate, a metal foil substrate, and an ultra-thin glass substrate. The display portion 152 is formed in the display body 151 using at least one kind of display element among liquid crystal displays (LCDs), organic light emitting diodes (OLEDs) and e-papers that can be fabricated on an ultra-thin and light substrate. The power supply 154 includes at least one of a polymer battery, a solar cell, and a fuel-cell battery, and may supply power to the display body 151 using the battery, etc. Various functional electronic devices selected by a user may be connected to the connection port 155 formed in the display body 151.

When a functional electronic device is connected through the connection port 155, information from the functional electronic device is transferred to a cellular phone or directly displayed on the display portion 152. The functional electronic device may be a medical sensor, such as a blood-sugar sensor, a blood-pressure sensor, a heartbeat sensor, etc., an optical sensor for controlling the luminance of the display elements according to the illumination of the surrounding environment, a radio frequency (RF) sensor for sensing and recognizing an RF signal as information, a temperature and humidity sensor for sensing temperature and humidity, an information processor, and so on. Meanwhile, in order to facilitate attachment, separation and electrical integration of the functional electronic device, a printed circuit board (PCB) may be formed on the various kinds of substrate, as mentioned above.

According to the above described constitution, when the power switch 156 is turned on in the I/O expansion device having the additional power supply 154, a signal is applied to the power supply 154, thereby beginning to supply power. Consequently, information provided by the input unit 104 of the cellular phone 100 or a functional electronic device connected through the connection port 155 is displayed on the display portion 152.

While the invention has been shown and described with reference to certain exemplary embodiments thereof, it will be understood by those skilled in the art that various changes in form and details may be made therein without departing from the spirit and scope of the invention as defined by the appended claims.

1. An input/output (I/O) expansion device for a portable electronic apparatus having a port to which an external expansion device can be connected, the I/O expansion device comprising:
a display body having at least one display portion; and
at least one I/O connector formed at a portion of the display body to be electrically and physically attached to and separated from the port of the portable electronic apparatus.

2. An input/output (I/O) expansion device for a portable electronic apparatus having a port to which an external expansion device can be connected, the I/O expansion device comprising:
a display body having at least one display portion;
at least one I/O connector formed at a portion of the display body; and
an interface cable connected to the I/O connector and the port to electrically and physically connect the display body with the portable electronic apparatus.

3. The I/O expansion device of claim 1, wherein the display body further comprises at least one functional electronic device connection port for connection with a functional electronic device to be electrically and physically attached to and separated from the I/O expansion device, and displays information received from the functional electronic device connected with the connection port on the display portion or transfers the information to the portable electronic apparatus.

4. The I/O expansion device of claim 2, wherein the display body further comprises at least one functional electronic device connection port for connection with a functional electronic device to be electrically and physically attached to and separated from the I/O expansion device, and displays information received from the functional electronic device connected with the connection port on the display portion or transfers the information to the portable electronic apparatus.

5. The I/O expansion device of claim 3, wherein the functional electronic device comprises at least one of a blood-sugar sensor, a blood-pressure sensor, a heartbeat sensor, a radio frequency (RF) sensor, an optical sensor, a temperature sensor, a humidity sensor, and an information processor.

6. The I/O expansion device of claim 4, wherein the functional electronic device comprises at least one of a blood-sugar sensor, a blood-pressure sensor, a heartbeat sensor, a radio frequency (RF) sensor, an optical sensor, a temperature sensor, a humidity sensor, and an information processor.

7. The I/O expansion device of claim 1, further comprising:
a power supply formed in the display body to supply power to the display body.

8. The I/O expansion device of claim 2, further comprising:
a power supply formed in the display body to supply power to the display body.

9. The I/O expansion device of claim 7, wherein the power supply comprises at least one of a polymer battery, a solar cell, and a fuel-cell battery.

10. The I/O expansion device of claim 8, wherein the power supply comprises at least one of a polymer battery, a solar cell, and a fuel-cell battery.

11. The I/O expansion device of claim 1, wherein the display body uses one of a plastic substrate, an ultra-thin glass substrate in which at least one of an upper surface and a lower surface is coated with a polymer layer, and a metal foil substrate.

12. The I/O expansion device of claim 2, wherein the display body uses one of a plastic substrate, an ultra-thin glass substrate in which at least one of an upper surface and a lower surface is coated with a polymer layer, and a metal foil substrate.

13. The I/O expansion device of claim 11, wherein a printed circuit board (PCB) for facilitating electrical and physical attachment and separation of a functional electronic device is formed on the substrate used in the display body.

14. The I/O expansion device of claim 12, wherein a printed circuit board (PCB) for facilitating electrical and physical attachment and separation of a functional electronic device is formed on the substrate used in the display body.

15. The I/O expansion device of claim 11, wherein the plastic substrate is formed of one of polyethylene terephthalate (PET), polycarbonate (PC), polyethersulfone (PES), and polyimide (PI).

16. The I/O expansion device of claim 12, wherein the plastic substrate is formed of one of polyethylene terephthalate (PET), polycarbonate (PC), polyethersulfone (PES), and polyimide (PI).

17. The I/O expansion device of claim 11, wherein the metal foil substrate is formed of stainless steel or aluminum.

18. The I/O expansion device of claim 12, wherein the metal foil substrate is formed of stainless steel or aluminum.

19. The I/O expansion device of claim 1, wherein the display portion is integrated using at least one of a liquid crystal display (LCD), an organic light emitting diode (OLED), and e-paper.

20. The I/O expansion device of claim 1, wherein the display portion is integrated using at least one of a liquid crystal display (LCD), an organic light emitting diode (OLED), and e-paper.
